(19) United States
(12) Patent Application Publication
(10) Pub. No.: US 2010/0254485 A1
(43) Pub. Date: Oct. 7, 2010

(54) PILOT TRANSMISSION METHOD, MIMO TRANSMISSION DEVICE, AND MIMO RECEPTION DEVICE

(75) Inventors: Isamu Yoshii, Kanagawa (JP); Atsushi Sumasu, Kanagawa (JP); Tomohiro Imai, Kanagawa (JP); Hidenori Kayama, Kanagawa (JP); Hidenori Matsuo, Kanagawa (JP); Yoshiko Saito, Kanagawa (JP); Seigo Nakao, Kanagawa (JP); Shinsuke Takaoka, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/746,750

(22) PCT Filed: Dec. 12, 2008
(86) PCT No.: PCT/JP2008/003751

§ 371 Date: Jun. 7, 2010

(30) Foreign Application Priority Data
Dec. 14, 2007 (JP) 2007-323463
Aug. 26, 2008 (JP) 2008-216920

(51) Int. Cl. H04L 27/00

(52) U.S. Cl. 375/295; 375/316

(57) ABSTRACT

It is possible to provide a novel pilot transmission method which can calculate an accurate channel estimation value, a MIMO transmission device using the pilot transmission method, and a MIMO reception device which communicates with the MIMO transmission device. The MIMO transmission device (100) includes phase adjustment units (130-1, 130-2) which are controlled by a pilot transmission control unit (170) to multiply parallel pilot signals by a phase adjustment coefficient group so as to adjust the pilot signal transmission timing. The pilot transmission control unit (170) differentiates the order of the transmitting antennas in accordance with the pilot transmission timing between an even-number subcarrier group and an odd-number subcarrier group. At a reception side, a path not influenced by the inter-path interference is extracted for each of the combinations of the transmitting antennas and the subcarrier groups. A channel estimation value is calculated according to the extracted path so as to improve the channel estimation accuracy.

### TECHNICAL FIELD

The present invention relates to a pilot transmission method, a MIMO transmission apparatus and a MIMO reception apparatus.

### BACKGROUND ART

In recent years, MIMO (Multiple-Input/Multiple-Output) communication is attracting attention as a technology to allow communication of large volume of data such as images. With this MIMO communication, a plurality of antennas on the transmitting side transmit different transmission data (substreams) and received data formed by mixing a plurality of transmission data on channels is separated into the original transmission data on the receiving side. When this separation processing is performed, channel estimation values are required.

Patent Document 1 discloses a method of channel estimation in a MIMO communication system (OFDM-MIMO communication system) adopting the OFDM (Orthogonal Frequency Division Multiplexing) system.

On the MIMO transmission apparatus side of the OFDM-MIMO communication system disclosed in Patent Document 1, first, an OFDM symbol (“pilot OFDM symbol” hereinafter) is formed by signal sequences generated in a pilot signal sequence generating section. In this pilot OFDM symbol, the same signal is superimposed on all subcarriers, and therefore the pilot OFDM appears an impulse in the time domain. Then, these pilot OFDM symbols are subjected to cyclic shift processing with different amounts of shift per antenna, attached cyclic prefixes (CPs), and transmitted from a plurality of antennas.

On the MIMO reception apparatus side of the OFDM-MIMO communication system, a range of k samples from the initial first position in a pilot OFDM symbol is actually used as “pilot.” The MIMO transmission apparatus shifts pilots by k samples in the time domain between antennas by applying cyclic shift processing to pilot OFDM symbols. Here, in order to prevent interference between pilot OFDM symbols transmitted from different antennas, k samples are practically set equal to or more than the maximum multipath delay time.

Patent Document 2 discloses a method of shifting impulses other than the above-described cyclic shift. As shown in FIG. 1, transmitting antenna 1 transmits the same signals through all subcarriers. Therefore, as described above, a transmitted OFDM signal is formed of an impulse in the time domain. Meanwhile, transmitting antenna 2 transmits an impulse delayed k samples from the impulse from antenna 1. It is possible to delay an impulse by k samples by multiplying the m-th subcarrier by exp(−2 p*k*m/N_sub), which are a set of phase adjustment coefficients. Here, N_sub means the total number of FFT points.

When receiving each pilot OFDM symbol transmitted as described above, (pilot transmission timings from respective antennas included in these pilot OFDM symbol are shifted), the MIMO reception apparatus first removes the CP. Then, the MIMO reception apparatus samples the first k-sample part and the following parts in each received pilot OFDM symbol without the CP. That is, the MIMO reception apparatus performs separating processing of pilots transmitted from respective transmitting antennas on the assumption that the first k-sample part is the multipath of transmitting antenna 1 and the following parts are the multipath of antenna 2. FFT processing is performed on both sampled parts. This processing is performed per receiving antenna of the MIMO reception apparatus. Then, the results of FFT processing calculated for all combinations of transmitting antennas and receiving antennas are used to calculate channel estimation values.

### Patent Document 1: Japanese Patent Application Laid-Open No. 2007-20072

### Patent Document 2: Japanese Patent Application Laid-Open No. 2006-197520

### DISCLOSURE OF INVENTION

### Problems to be Solved by the Invention

However, if the maximum multipath delay time is long and exceeds the difference in times to transmit pilots between antennas, received pilots overlap. As a result of this, the accuracy of channel estimation deteriorates. That is, when the channel estimating section on the receiving side performs separation processing using time windows, the time window for sampling pilots transmitted from antenna 1 is set for the normal time when the above-described overlap does not occur. Therefore, if the maximum multipath delay time is long, it is not possible to sample all paths of pilots from antenna 1 using that time window. In addition, paths delayed for a long time are sampled using the time window for sampling pilots transmitted from antenna 2. That is, inter-path interference occur.

Here, a sample length for allocating transmitting antennas, that is, the above-described k samples, is determined in accordance with the maximum delay time, under the limitation that k samples do not exceed an OFDM symbol. In addition, there is an additional limitation that the total of “difference k” in transmission timings provided between pilots transmitted through one OFDM symbol does not exceed the CP length. That is, as the number of antennas of a MIMO transmission apparatus is greater, it is necessary to reduce k. Therefore, the probability that the maximum delay time exceeds the difference in pilot transmission timings increases, and inter-path interference occurs with increased frequency, so that the accuracy of channel estimation further deteriorates.

It is therefore an object of the present invention to provide a new pilot transmission method to allow the calculation of more accurate channel estimation values, a MIMO transmission apparatus using this pilot transmission method and a MIMO reception apparatus that communicates with this MIMO transmission apparatus.

### Means for Solving the Problem

The pilot transmission method according to the present invention is a pilot transmission method in a MIMO transmission apparatus that transmits pilots in the form of impulses. The pilot transmission method includes the steps of: forming parallel pilot signals; adjusting timings to transmit the pilots by multiplying the parallel pilot signals by a set of phase adjustment coefficients; and transmitting the pilots at the adjusted timings from a plurality of transmitting antennas in pilot transmission symbol periods. The order of the plurality of transmitting antennas in accordance with the timings to transmit the pilots varies per subcarrier group in the same pilot transmission symbol period.

The MIMO transmission apparatus according to the present invention to transmit pilots in the form of impulses includes: a parallel pilot signal forming section that forms parallel pilot signals; and a pilot transmitting section that has a phase adjusting section to adjust transmission timings by multiplying the parallel pilot signals by a set of phase adjustment coefficients, and transmits the pilots from a plurality of transmitting antennas in pilot transmission symbol periods. The pilot transmitting section varies, per subcarrier group, an order of the plurality of transmitting antennas in accordance with timings to transmit the pilots in the same pilot transmission symbol period.

The MIMO reception apparatus according to the present invention to receive pilot symbols transmitted such that an order of a plurality of transmitting antennas in accordance with pilot transmission timings varies per subcarrier group in the same pilot transmission symbol period includes: a group delay profile creating section that separates the received pilot symbols into components for each subcarrier group and creates a group delay profile corresponding to each subcarrier group; a sampling section that samples partial delay profiles of first predetermined samples and partial delay profiles of last predetermined samples in each group delay profile; a combining section that combines a first partial delay profile and an last partial delay profile sampled in different group delay profiles after adjusting their reference positions; and a channel estimation value calculating section that calculates channel estimation values based on a combined delay profile corresponding to each transmitting antenna obtained in the combining section.

### ADVANTAGEOUS EFFECTS OF INVENTION

According to the present invention, it is possible to provide a new pilot transmission method to allow the calculation of more accurate channel estimation values, a MIMO transmission apparatus using this pilot transmission method and a MIMO reception apparatus that communicates with this MIMO transmission apparatus.

### BRIEF DESCRIPTION OF DRAWINGS

FIG. 1 is a drawing explaining a conventional method of shifting impulses;

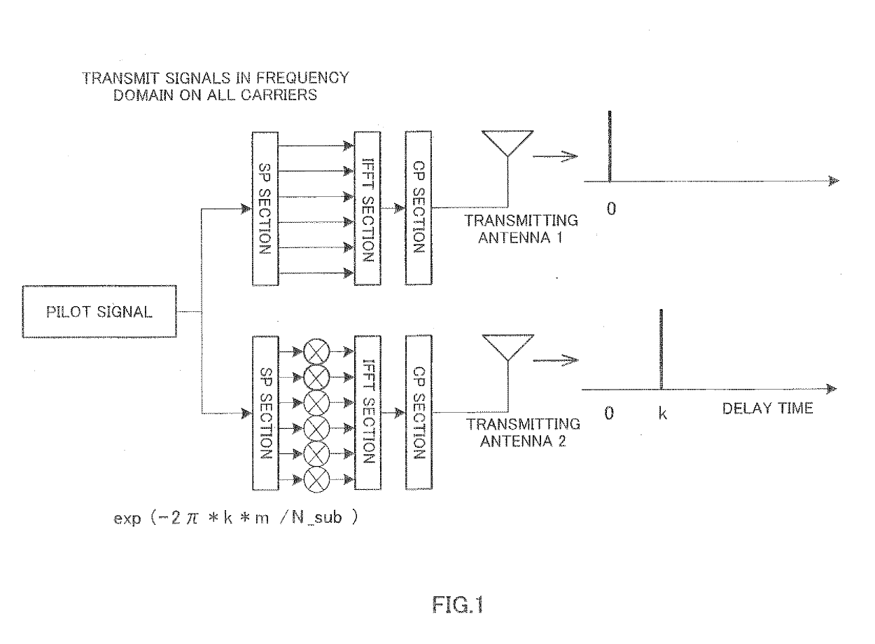

FIG. 2 is a block diagram showing a MIMO transmission apparatus according to embodiment 1 of the present invention;

FIG. 3 is a block diagram showing a configuration of the phase adjustment processing section in FIG. 2;

FIG. 4 is a block diagram showing a configuration of a MIMO reception apparatus according to embodiment 1;

FIG. 5 is a drawing explaining processing in the phase adjustment processing section;

FIG. 6 is a drawing explaining operations of a MIMO-OFDM communication system according to embodiment 1;

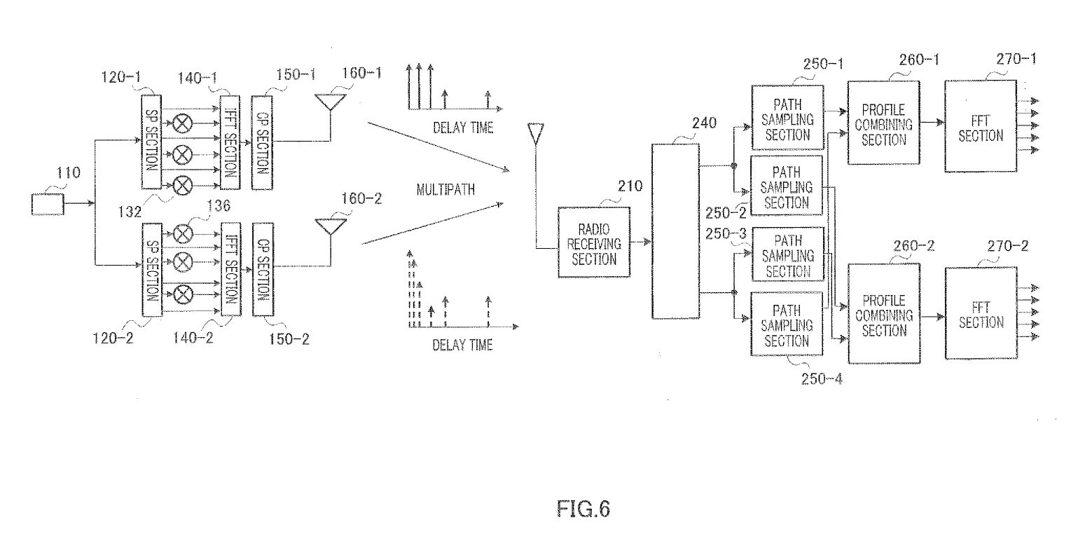

FIG. 7 is a drawing explaining operations of the MIMO reception apparatus according to embodiment 1;

FIG. 8 is a drawing explaining operations of a MIMO reception apparatus according to embodiment 2;

FIG. 9 is a drawing explaining operations of a MIMO transmission apparatus and a MIMO reception apparatus according to embodiment 3;

FIG. 10 is a drawing explaining operations of a MIMO transmission apparatus and a MIMO reception apparatus according to embodiment 4;

FIG. 11 is a drawing explaining operations of a MIMO transmission apparatus according to embodiment 5;

FIG. 12 is a drawing explaining the technology to be compared;

FIG. 13 is a drawing showing the trend of the quality of channel estimation values obtained on the receiving side when pilots are transmitted in the transmission order shown in FIG. 12; and

FIG. 14 is a drawing showing the trend of the quality of channel estimation values obtained on the receiving side when pilots are transmitted in the transmission order shown in FIG. 11.

### BEST MODE FOR CARRYING OUT THE INVENTION

Now, embodiments of the present invention will be described in detail with reference to the accompanying drawings. Here, in embodiments, the same parts will be assigned the same reference numerals and overlapping descriptions will be omitted.

### Embodiment 1

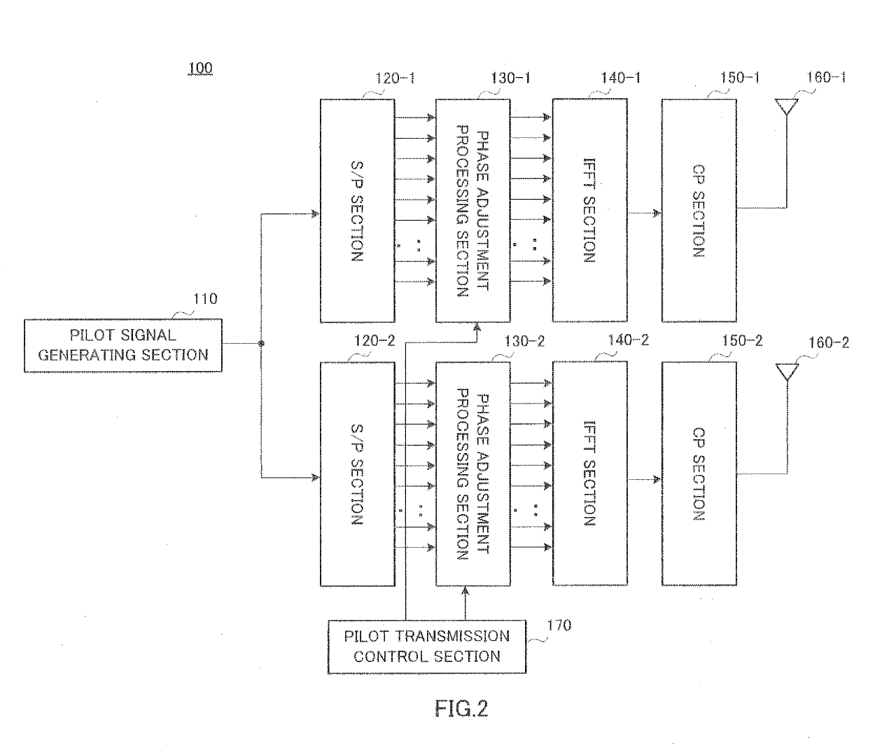

As shown in FIG. 2, MIMO transmission apparatus 100 in the MIMO-OFDM communication system according to the present embodiment has pilot signal generating section 110, S/P sections 120-1 and 2, phase adjustment processing sections 130-1 and 2, IFFT sections 140-1 and 2, CP sections 150-1 and 2, transmitting antennas 160-1 and 2 and pilot transmission control section 170. Here, a case will be described where there are two transmitting antennas, that is, there are two transmitting systems, for ease of explanation.

Pilot signal generating section 110 generates pilot signal sequences and outputs them to S/P sections 120. Pilot signal generating section 110 outputs pilot signals in accordance with symbol timings.

S/P sections 120 serial-parallel convert pilot signal sequences generated in pilot signal generating section 110 and output a plurality of obtained pilot parallel signals to phase adjustment processing sections 130. The plurality of pilot parallel signals correspond to subcarriers of OFDM signals, respectively.

Phase adjustment processing section 130-1 and 2 receive sets of phase adjustment coefficients from pilot transmission control section 170 as input and adjust the phase per subcarrier. Phase adjustment processing sections 130-1 and 2 multiply each subcarrier group into which a plurality of subcarriers used for OFDM communication are grouped, by the set of phase adjustment coefficients. The sets of phase adjustment coefficients by which subcarrier groups are multiplied are different between phase adjustment processing sections 130-1 and 2. In addition, in the same pilot OFDM symbol, sets of phase adjustment coefficients by which respective subcarrier groups are multiplied are different between phase adjustment processing sections 130-1 and 2.

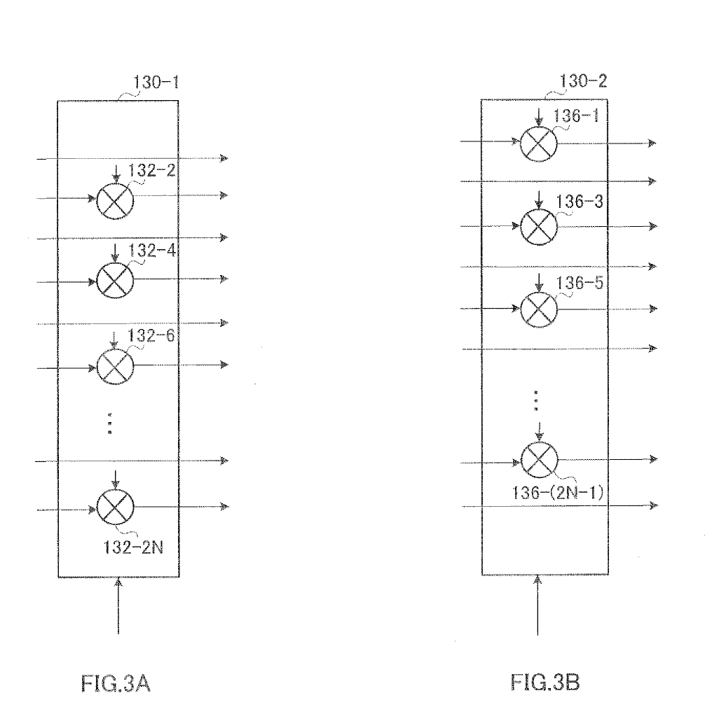

Phase adjustment processing sections 130-1 and 2 have the configurations shown in FIGS. 3A and B, respectively.

Phase adjustment processing 130-1 adjusts the phases of the first subcarrier group. Here, even-numbered subcarriers constitute the first subcarrier group and odd-numbered subcarriers constitute the second subcarrier group.

Phase adjustment processing section 130-1 has multipliers 132-2, . . . , 2N that multiply subcarriers respectively corresponding to branch numbers by phase adjustment coefficients. Here, the total number of subcarriers is 2N.

Meanwhile, phase adjustment processing section 130-2 adjusts the phases of the second subcarrier group. Phase adjustment processing section 130-2 has multipliers 136-1, 3, . . . , (2N−1).

Here, as for respective phase adjustment processing section 130-1 and phase adjustment processing section 130-2, there are subcarriers not subjected to multiplication by sets of phase adjustment coefficients in the multipliers. Although the multipliers corresponding to those subcarriers are not shown, FIG. 3 shows the same case as that multipliers corresponding to those subcarriers are provided and all sets of phase adjustment coefficients multiplied in these multipliers are one.

IFFT sections 140 form OFDM signals by inverse Fourier transforming subcarrier signals after phase adjustment. Here, the above-described S/P sections 120, phase adjustment processing sections 130 and IFFT sections 140 function as an OFDM generating section. Then, in a generated pilot OFDM symbol, transmission timings are shifted by k samples between subcarrier groups by processing through phase adjustment processing sections 130.

CP sections 150 add cyclic prefixes to OFDM signals formed in IFFT sections 140. OFDM signals with CPs are subjected to predetermined radio transmission processing and then transmitted via transmitting antennas 160.

Pilot transmission control section 170 controls timings to transmits pilots corresponding to each combination of transmitting systems and subcarrier groups by outputting the set of phase adjustment coefficients to phase adjustment processing sections 130.

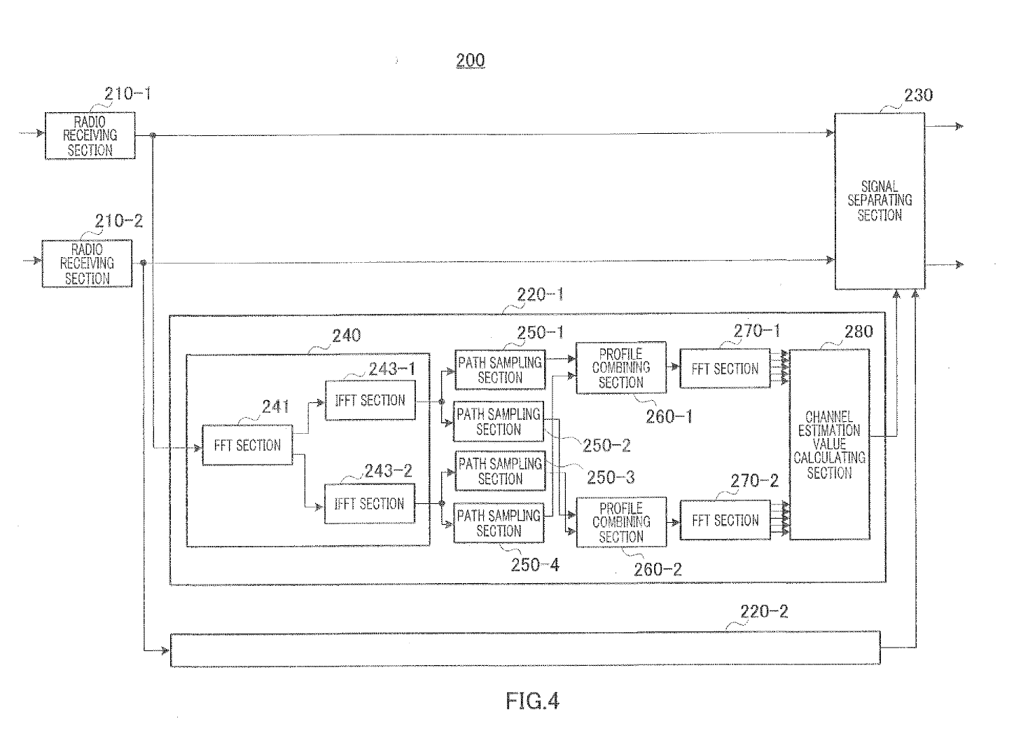

As shown in FIG. 4, MIMO reception apparatus 200 in the MIMO-OFDM communication system according to the present embodiment has radio receiving sections 210 respectively corresponding to a plurality of receiving antennas (not shown), plurality of channel estimating sections 220 respectively corresponding to radio receiving sections 210 and signal separating section 230. Here, a case will be described where there are two antennas, that is, there are two receiving systems, for ease of explanation.

Radio receiving sections 210-1 and 2 perform predetermined radio receiving processing (e.g. down-conversion and A/D conversion) on received signals received in respective corresponding receiving antennas, remove the CPs and transmit the obtained signals to respective corresponding channel estimating sections 220-1 and 2.

Channel estimating sections 220-1 and 2 receive OFDM signals to be received from respective corresponding radio receiving sections 210-1 and 2 and calculate channel estimation values using pilots included in these received OFDM signals. Each of channel estimating sections 220-1 and 2 calculates channel estimation values relating to respective subcarriers between the corresponding receiving antennas and transmitting antennas of MIMO transmission apparatus 100.

To be more specific, each of channel estimating sections 220 has group separating section 240, path sampling sections 250, profile combining sections 260, FFT sections 270 and channel estimation value calculating section 280.

Group separating section 240 separates received OFDM signals into components per subcarrier group and creates delay profiles respectively corresponding to subcarrier groups. Group separating section 240 has FFT section 241 and IFFT sections 243-1 and 2 respectively corresponding to subcarrier groups.

FFT section 241 transforms received pilot OFDM symbols from signals in the frequency domain to signals in the time domain by the Fourier transform. Moreover, FFT section 241 sorts transformed signals based on subcarrier groups. Here, since signals are divided into groups of odd-numbered subcarriers and even-numbered subcarriers, FFT section 241 outputs the signals of odd-numbered subcarriers to IFFT section 243-1 and outputs the signals of even-numbered subcarriers to IFFT section 243-2.

IFFT sections 243-1 and 2 transform inputted signals from signals in the frequency domain to signals in the time domain by the inverse Fourier transform and outputs transformed signals to path sampling sections 250. Here, the signals outputted from IFFT section 243-1 show the delay profile of the odd-numbered subcarrier group. Meanwhile, the signals outputted from IFFT section 243-2 show the delay profile of the even-numbered subcarrier group.

Path sampling sections 250 sample paths not influenced by inter-path interference in inputted delay profiles using preset time windows. That is, path sampling sections 250 sample part of the inputted delay profiles (partial delay profiles). Pairs of path sampling sections 250 are provided corresponding to respective subcarrier groups. The pair of path sampling sections 250-1 and 2 corresponds to the odd-numbered subcarrier group, and the pair of path sampling sections 250-3 and 4 corresponds to the even-numbered subcarrier group. Then, each of path sampling sections 250 making a pair extracts k samples from the beginning and extracts k samples from the end in the inputted delay profile. Path sampling sections 250-1 and 3 extract k samples from the beginning and path sampling section 250-2 and 4 extract k samples from the end in the inputted delay profile. The paths sampled in sampling sections 250 are inputted to the corresponding profile combining sections 260, respectively.

Profile combining sections 260 receive partial delay profiles as input and adjust their reference positions to combine the received partial delay profiles. The combined delay profile is inputted to FFT sections 270.

FFT sections 270 transform the inputted combined delay profile from signals in the time domain to signals in the frequency domain by the Fourier transform and outputs the resulting signals to channel estimation value calculating section 280.

Channel estimation value calculating section 280 calculates channel estimation values using the FFT processing results obtained in FFT sections 270.

Now, operations of MIMO transmission apparatus 100 and MIMO reception apparatus 200 in the MIMO-OFDM communication system having the above-described configuration will be described.

In MIMO transmission apparatus 100, pilots OFDM signals are generated by performing IFFT processing on pilot parallel signals obtained by serial-parallel converting pilot signals.

In MIMO transmission apparatus 100, phase adjustment processing sections 130-1 and 2 adjust phases per subcarrier group before IFFT processing. To be more specific, phase adjustment processing section 130-1 multiplies subcarrier signals belonging to the even-numbered subcarrier group by the set of phase adjustment coefficients. By this means, paying attention to a pilot OFDM symbol transmitted from transmitting antenna 160-1, the pilot impulses in even-numbered subcarriers are transmitted behind the pilot impulses in odd-numbered subcarriers. That is, pilot transmission timings of even-numbered subcarriers are k samples behind pilot transmission timings of odd-numbered subcarriers.

Meanwhile, phase adjustment processing section 130-2 multiplies subcarrier signals belonging to the odd-numbered subcarrier group by the set of phase adjustment coefficients. By this means, paying attention to a pilot OFDM symbol transmitted from transmitting antenna 160-2, the pilot impulses of odd-numbered subcarriers are transmitted behind the pilot impulses of even-numbered subcarriers. That is, pilot transmission timings of odd-numbered subcarriers are k samples behind pilot transmission timings of even-numbered subcarriers.

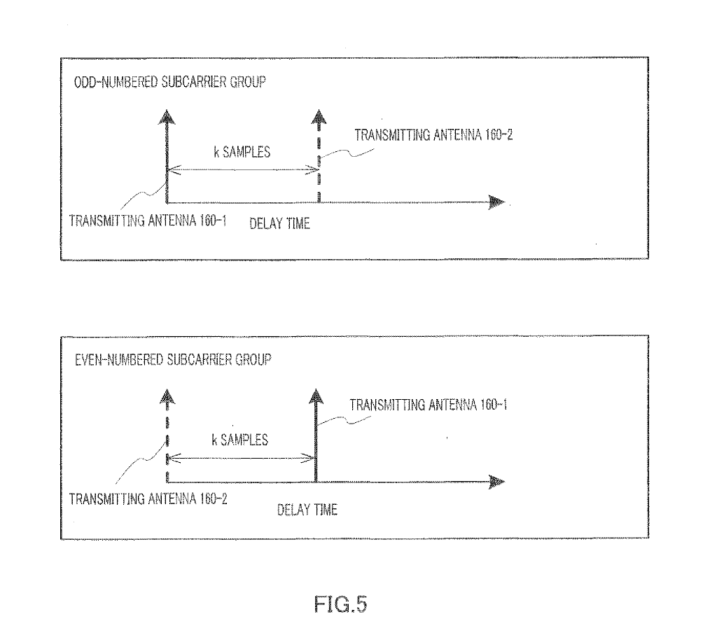

Moreover, paying attention to the odd-numbered subcarrier group, the pilot impulse transmitted from transmitting antenna 160-2 are transmitted k samples behind the pilot impulse transmitted from transmitting antenna 160-1 as shown in FIG. 5. Meanwhile, paying attention to the even-numbered subcarrier group, the pilot impulse transmitted from transmitting antenna 160-1 are transmitted k samples behind the pilot impulse transmitted from transmitting antenna 160-2 as shown in FIG. 5.

Thus, with both odd-numbered subcarrier group and even-numbered subcarrier group, pilot transmission timings are shifted by k samples between transmitting antennas. Moreover, the order of pilot transmission timings from transmitting antennas is reversed between the odd-numbered subcarrier group and the even-numbered subcarrier group.

Thus, OFDM symbols formed in respective transmitting systems are transmitted in the same pilot transmission symbol period.

Pilot OFDM symbols transmitted as described above go through a plurality of paths and then are received in MIMO reception apparatus 200.

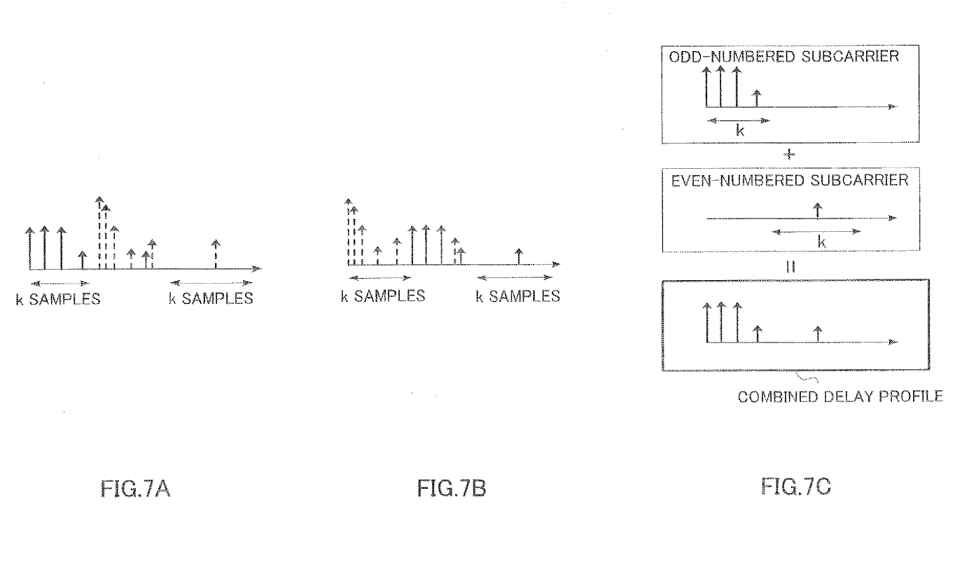

After performing radio receiving processing on received signals and removing the CPs, MIMO reception apparatus 200 separates the received OFDM signals into components per subcarrier group and creates delay profiles corresponding to respective subcarrier groups. FIG. 7A and FIG. 7B show the delay profile of the odd-numbered subcarrier group and the delay profile of the even-numbered subcarrier group obtained at this time, respectively.

Here, referring to FIG. 7A, since the maximum delay time of pilots transmitted from transmitting antenna 160-1 exceeds k samples, the most delayed path causes inter-path interference with pilots transmitted from transmitting antenna 160-1. On the other hand, the paths within the time window of the first k samples, among paths transmitted from transmitting antenna 160-1, are not influenced by inter-path interference. Moreover, the path within the time window of the last k samples, among paths transmitted from transmitting antenna 160-2, is not influenced by inter-path interference. Therefore, it is possible to sample partial delay profiles not influenced by inter-path interference by sampling paths using the time window of the first k samples and the time window of the last k samples.

On the other hand, referring to FIG. 7B, the paths influenced by inter-path interference in FIG. 7A are not influenced by inter-path interference here. The reason for this is that the order of pilot transmissions from antennas is reversed between the even-numbered subcarrier group and the odd-numbered subcarrier group on the transmitting side.

Then, the combined delay file (see FIG. 7C) is obtained by combining partial delay profiles sampled in path sampling sections 250, which are not influenced by inter-path interference, per transmitting antenna.

As described above, according to the present embodiment, in MIMO transmission apparatus 100 that transmits pilots in the form of impulses, phase adjustment processing sections 130-1 and 2 multiply parallel pilot signals by sets of phase adjustment coefficients through control from pilot transmission control section 170, so that pilot transmission timings are adjusted. Pilot transmission control section 170 varies, between the even-numbered subcarrier group and the odd-numbered subcarrier group, the order of a plurality of transmitting antennas in accordance with pilot transmission timings.

As a result of this, it is possible to change the positions of paths to be influenced by inter-path interference per combination of transmitting antennas and subcarrier groups. Therefore, on the receiving side, it is possible to form a combined delay profile corresponding to pilots transmitted from respective transmitting antennas by combining partial delay profiles formed by paths not influenced by inter-path interference. Since this combined delay profile excludes paths influenced by inter-path interference, it is possible to improve the accuracy of channel estimation by calculating channel estimation values based on this combined delay profile. That is, it is possible to realize the MIMO transmission apparatus to allow the calculation of more accurate channel estimation values.

MIMO reception apparatus 200 that receives pilots transmitted from MIMO transmission apparatus 100 has: group separating section 240 that separates received pilot symbols into components of each subcarrier group and forms group delay profiles corresponding to respective subcarrier groups; path sampling section 250 as a sampling means that samples partial delay profiles of predetermined first and last samples in each group delay profile; profile combining section 260 as a combining means that combines the first partial delay profile and the last partial delay profile that have been sampled in different group delay profiles, after adjusting their reference positions; and channel estimation value calculating section 280 that calculates channel estimation values based on the combined delay profile corresponding to respective transmitting antennas obtained in profile combining section 260.

By this means, it is possible to form a combined delay profile corresponding to pilots transmitted from respective transmitting antennas by combining partial delay profiles formed by paths not influenced by inter-path interference. Since this combined delay profile excludes paths influenced by inter-path interference, it is possible to improve the accuracy of channel estimation by calculating channel estimation values based on this combined delay profile. That is, it is possible to realize the MIMO reception apparatus to allow the calculation of more accurate channel estimation values.

Here, although a case has been explained in the above description where subcarriers are classified into an odd-numbered subcarrier group and an even-numbered subcarrier group, the present invention is not limited to this and other grouping methods may be applicable.

For example, when there are three transmitting antennas, subcarriers may be grouped based on the remainders obtained by dividing subcarrier numbers by three. At this time, preferably, the first transmitting antenna transmits pilots in the order of the first, second and third subcarrier groups, the second transmitting antenna transmits pilots in the order of the third, first and second subcarrier groups, and the third transmitting antenna transmits pilots in the order of the second, third and first subcarrier groups.

That is, preferably, the order of a plurality of transmitting antennas in accordance with pilot transmission timings varies per subcarrier group in the same pilot transmission symbol period.

By this means, since pilots transmitted on respective subcarrier groups are placed first or last in order in any one of transmitting antennas, it is possible to sample partial delay profiles not influenced by inter-path interference by sampling the predetermined first and last samples of a pilot OFDM symbol on the receiving side.

For example, when there are three receiving antennas, a pair of path sampling sections, one profile combining section and one FFT section are added to the configuration shown in FIG. 4.

Here, although a ease has been explained in the above description where pilot transmission timings through corresponding subcarriers are changed per transmitting antenna. However, pilot transmission timings may vary per transmitting antenna in one pilot transmission symbol period, while the order of transmitting antennas arranged according to pilot transmission timings may vary between pilot transmission symbol periods between a plurality of consecutive pilot transmission symbol periods. That is, pilot transmission timings may be shifted in the time domain. This allows the same effect as in the present embodiment. However, it is possible to execute all patterns of the transmission order in a short period by shifting pilot transmission timings in the frequency domain in the same way as in the present embodiment, so that it is possible to improve the efficiency of pilot transmission.

### Embodiment 2

With embodiment 1, a combined delay profile is created by sampling paths using a time window of the same time length as the time difference in transmission between pilots provided on the transmitting side. That is, with embodiment 1, selective combining processing is performed. On the other hand, with embodiment 2, a combined delay profile is created by sampling paths using the time window of the time length longer than the time difference in transmission between pilots provided on the transmitting side and adjusting their reference positions to combine partial delay profiles of sampled paths. At this time, the powers of the paths appearing in the same positions are combined. By this means, it is possible to improve SNR. Here, the configuration of the MIMO reception apparatus according to the present embodiment is the same as in embodiment 1, so that the configuration block diagram in FIG. 4 will be used for explanation.

Path sampling section 250 samples paths in inputted delay profiles using a time window encompassing the range from the first path to the last path of pilots transmitted from respective transmitting antennas.

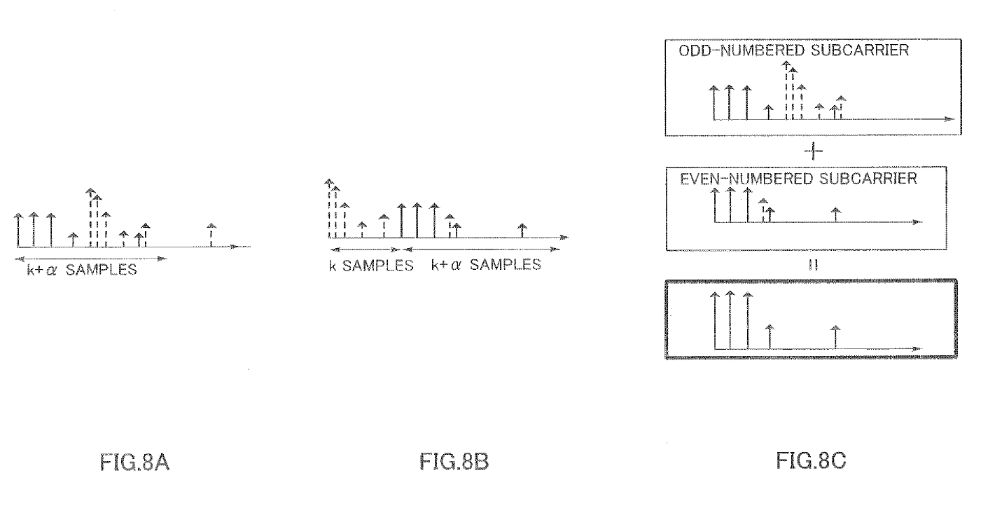

To be more specific, path sampling section 250-1 samples from the first path to the last path of pilots on the odd-numbered subcarrier group transmitted from transmitting antenna 160-1 using the time window shown in FIG. 8A. That is, path sampling section 250-1 samples paths using a time window having a time width of k+a from the beginning of a pilot OFDM symbol. Here, a is equivalent to a longer period than the maximum delay time k initially estimated. These paths sampled here includes paths of the pilots transmitted from transmitting antenna 160-2.

Meanwhile, path sampling section 250-2 samples pilots from the first path to the last path on the even-numbered subcarrier group transmitted from transmitting antenna 160-1, using the time window as shown in FIG. 8B. That is, path sampling section 250-2 samples paths using the time window having a time width of k+a from the k-th samples in a pilot OFDM symbol.

Path sampling section 250-3 uses the same time window as in path sampling section 250-2 while path sampling section 250-4 uses the same time window as in path sampling section 250-1.

Profile combining section 260 combines a plurality of inputted sampled delay profiles after adjusting their reference positions. At this time, as shown in FIG. 8C, the powers of the paths appearing in the same positions in both sampled delay profiles are combined while the paths appearing in positions in only one sampled delay profile are discarded. Thus, only the paths on the desired subcarrier group remain in the combined delay profile and the powers of these paths are combined. Therefore, it is possible to improve SNR.

### Embodiment 3

With embodiment 3, the difference in pilot transmission timings varies between the first frame and the second frame. Here, respective configurations of the MIMO transmission apparatus and the MIMO reception apparatus are the same as in embodiment 1, so that the configuration block diagrams of FIG. 2 and FIG. 4 are used for explanation.

Pilot transmission control section 170 outputs different sets of phase adjustment coefficients between the first frame and the second frame to phase adjustment processing sections 130. By this means, it is possible to change, between frames, the difference in transmission timings provided between pilots.

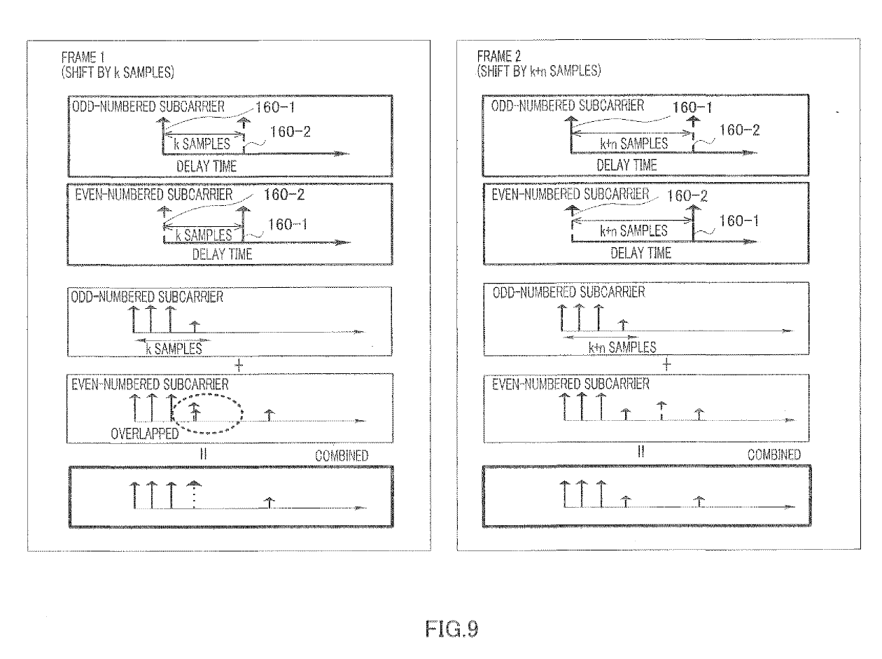

For example, as shown in FIG. 9, pilot transmission timings are shifted by k samples in frame 1 while pilot transmission timings are shifted by k+n samples in frame 2.

Here, as shown in FIG. 9, when a combined delay profile is created in frame 1, it sometimes happens that paths transmitted from different transmitting antennas overlap. At this time, in frame 1, the path corresponding to transmitting antenna 160-2, which is an interfering path, is included in the combined delay profile corresponding to transmitting antenna 160-1, so that the accuracy of channel estimation deteriorates.

However, with the present embodiment, the difference in transmission timings provided between pilots transmitted from transmitting antenna 160-1 and pilots transmitted from transmitting antenna 2 is changed between frames. By this means, it is possible to prevent the situation in which paths transmitted from different transmitting antennas are constantly overlap. Then, it is possible to obtain channel estimation values little influenced by inter-pass interference by averaging channel estimation values over a plurality of frames. By this means, it is possible to improve the accuracy of channel estimation. Here, in addition, it is possible to improve the accuracy of channel estimation by using channel estimation values not influenced by interfering paths, which are obtained in the frame in which paths do not overlap.

### Embodiment 4

With embodiment 3, the difference in pilot transmission timings is fixed between transmitting antennas and also between subcarrier groups of the same antenna in one frame. On the other hand, with embodiment 4, the difference in transmission timings provided between pilots transmitted from different transmitting antennas varies between the even-numbered subcarrier group and the odd-numbered subcarrier group in one frame.

Pilot transmission control section 170 outputs different sets of phase adjustment coefficients between the first frame and the second frame, to phase adjustment processing sections 130. In addition, pilot transmission control section 170 outputs respective different phase adjustment coefficients to phase adjustment processing section 130-1 and phase adjustment processing section 130-2 in the same frame. By this means, it is possible to vary the difference between pilot transmission timings from transmitting antenna 160-1 and pilot transmission timings from transmitting antenna 160-2 in first and second frames, and it is possible to vary, between the first and second frames, the difference in transmission timings provided between pilots from different transmitting antennas for each subcarrier group.

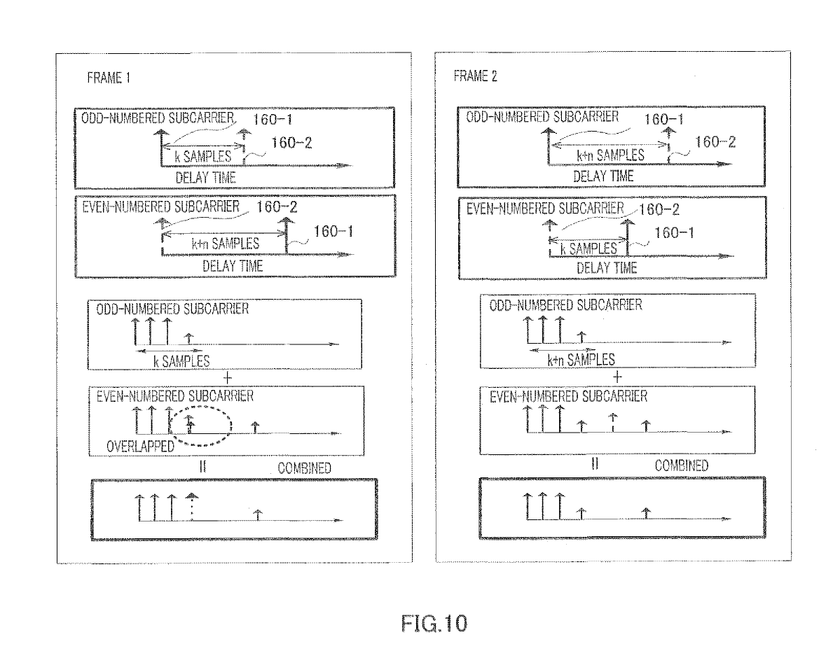

For example, in frame 1, pilot transmission timings of the odd-numbered subcarrier group is shifted by k samples between pilots from different transmitting antennas, while pilot transmission timings of the even-numbered subcarrier group is shifted by k+n samples between pilots from different transmitting antennas as shown in FIG. 10.

On the other hand, in frame 2, pilot transmission timings of the odd-numbered subcarrier group is shifted by k+n samples between pilots from different transmitting antennas while pilot transmission timings of the even-numbered subcarrier group is shifted by k samples between pilots from different transmitting antennas.

Here, as shown in FIG. 10, when a combined delay profile is created in frame 1, it sometimes happens that paths transmitted from different transmitting antennas overlap. At this time, in frame 1, the path corresponding to transmitting antenna 160-2, which is an interfering path, is included in the combined delay profile corresponding to transmitting antenna 160-1, so that the accuracy of channel estimation deteriorates.

However, it is possible to improve the accuracy of channel estimation in the same way as in embodiment 3, by the above-described embodiment.

### Embodiment 5

Embodiment 5 relates to a case where the MIMO transmission apparatus has three or more transmitting antennas. That is, the MIMO transmission apparatus according to embodiment 5 has three or more transmitting systems each composed of a S/P section, a phase adjustment processing section, an IFFT section and a CP section (respectively corresponding to S/P section 120, phase adjustment processing section 130, IFFT section 140 and CP section 150 in MIMO transmission apparatus 100).

The MIMO transmission apparatus according to embodiment 5 transmits pilots such that the order of a plurality of transmitting antennas in accordance with pilot transmission timings varies per subcarrier group in the same pilot transmission symbol period in the same way as in MIMO transmission apparatus 100.

To be more specific, the MIMO transmission apparatus according to embodiment 5 transmits pilots such that the order of a plurality of transmitting antennas in accordance with pilot transmission timings reverses between the even-numbered subcarrier group and the odd-numbered subcarrier group in a pilot transmission symbol period (e.g. one OFDM symbol).

Here, the MIMO transmission apparatus according to embodiment 5 transmits pilots such that a pair of the beginning transmitting antenna and the last transmitting antenna in the first pilot transmission symbol period differs from a pair of the beginning transmitting antenna and the last transmitting antenna in the second pilot transmission symbol period closest to the first pilot transmission symbol period.

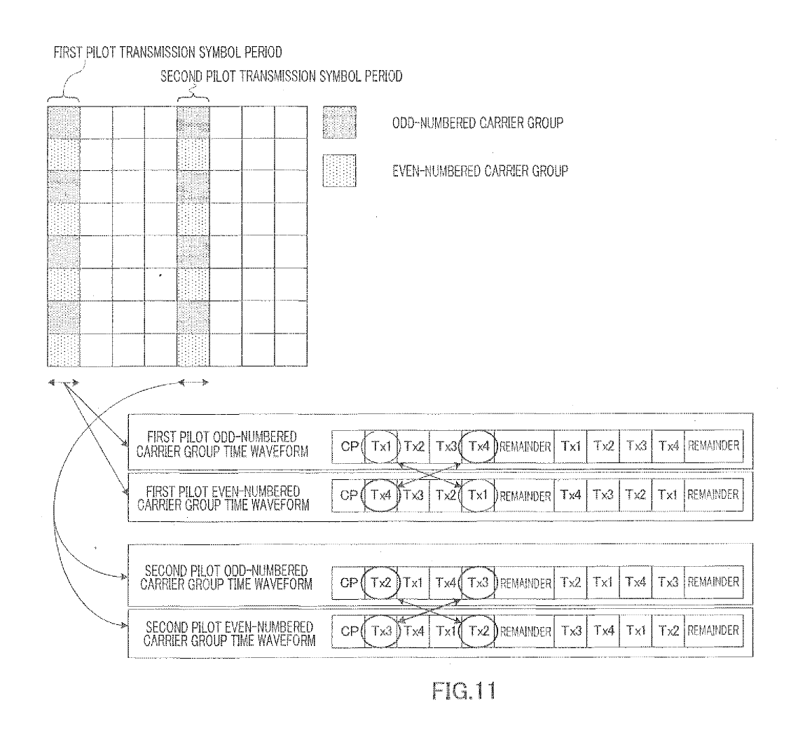

FIG. 11 is a drawing explaining operations of the MIMO transmission apparatus according to embodiment 5. FIG. 11 shows the situation of pilot transmission in the case where the MIMO transmission apparatus has four transmitting antennas (Tx1, Tx2, Tx3, and Tx4).

As shown in FIG. 11, the order of pilot transmission timings of the odd-numbered subcarrier group is Tx1, Tx2, Tx3 and Tx4, and the order of pilot transmission timings of the even-numbered subcarrier group is Tx4, Tx3, Tx2 and Tx1 in the first pilot transmission symbol period. Meanwhile, the order of pilot transmission timings of the odd-numbered subcarrier group is Tx2, Tx1, Tx4 and Tx3 and the order of pilot transmission timings of the even-numbered subcarrier group is Tx3, Tx4, Tx1 and Tx2 in the second pilot transmission symbol period.

That is, the pair of the beginning transmitting antenna and the last transmitting antenna in the first pilot transmission symbol period is composed of Tx1 and Tx4, while the pair of the beginning transmitting antenna and the last transmitting antenna in the second pilot transmission symbol period is composed of Tx2 and Tx3 other than Tx1 and Tx4.

(Technology to be Compared)

As described above, first, pilot signals transmitted from the beginning transmitting antenna are not subjected to interference from signals having been transmitted earlier, and the pilot signal transmitted from the last transmitting antenna are not subjected to interference from signals transmitted afterward. On the other hand, pilot signals transmitted from transmitting antennas other than the beginning transmitting antenna and the last transmitting antenna are likely to be subjected to interference from signals transmitted just before and after.

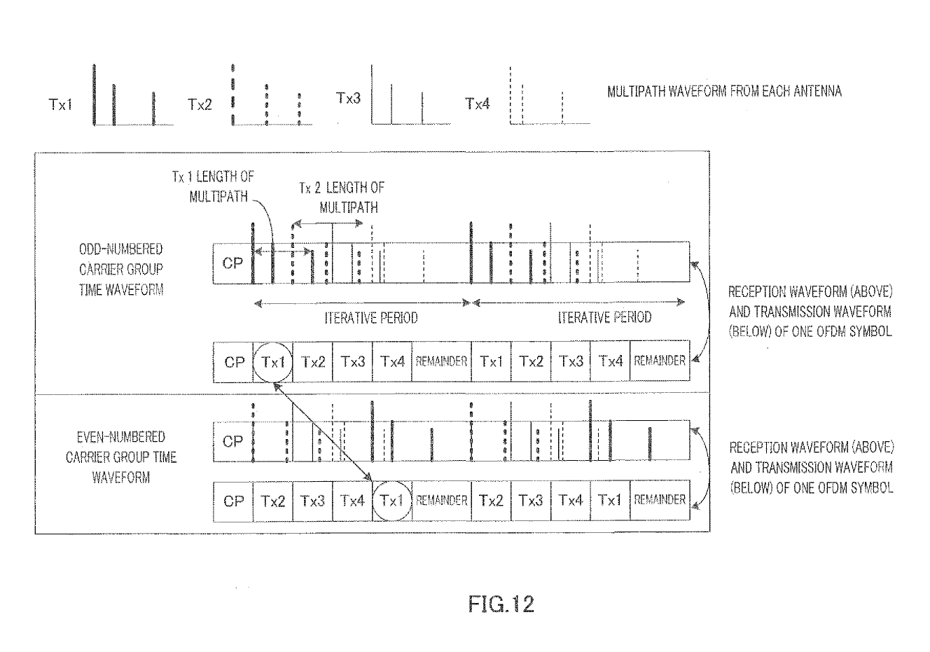

FIG. 12 is a drawing explaining the technology to be compared. For example, when pilots are transmitted from antennas in the order in accordance with the pilot transmission timings as shown in FIG. 12, Tx1 is the beginning transmitting antenna for the odd-numbered subcarrier group but is the last transmitting antenna for the even numbered subcarrier group. Therefore, on the receiving side, it is possible to create a combined delay profile in which the influence of inter-path interference is eliminated as for pilots transmitted from Tx1. However, the other transmitting antennas are other than the beginning transmitting antenna and the last transmitting antenna in at least one of the odd-numbered subcarrier group and the even-numbered subcarrier group. Therefore, as for these transmitting antennas (Tx2, Tx3 and Tx4), unlike Tx1, it is not possible to create the combined delay profile excluding the influence of inter-pass interference.

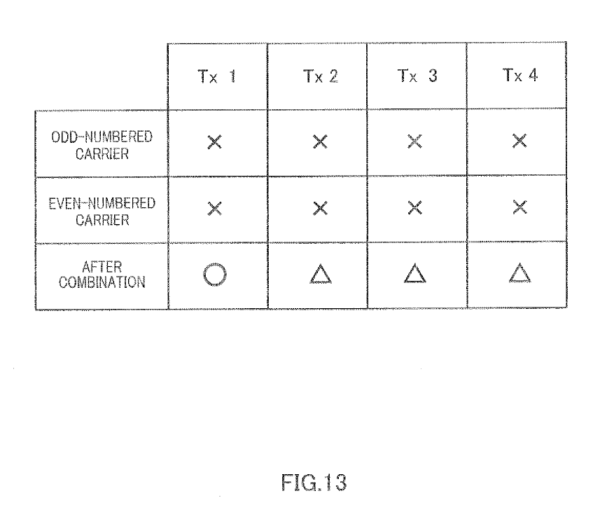

FIG. 13 is a drawing showing the trend of the quality of channel estimation values obtained on the receiving side when pilots are transmitted in the transmission order shown in FIG. 12. As shown in FIG. 13, pilots transmitted from Tx1, Tx2, Tx3 and Tx4 are subjected to interference from at least one of the previous and next pilots. Therefore, as for every Tx1, Tx2, Tx3 and Tx4, the accuracy of channel estimation values obtained by using pilots transmitted on the odd-numbered subcarrier group or the even-numbered subcarrier group is not good.

Here, when channel estimation values are calculated based on the combined delay profile, the accuracy of channel estimation for Tx1 improves. However, the accuracy of channel estimation for Tx2, Tx3 and Tx4 does not improve as compared with Tx1.

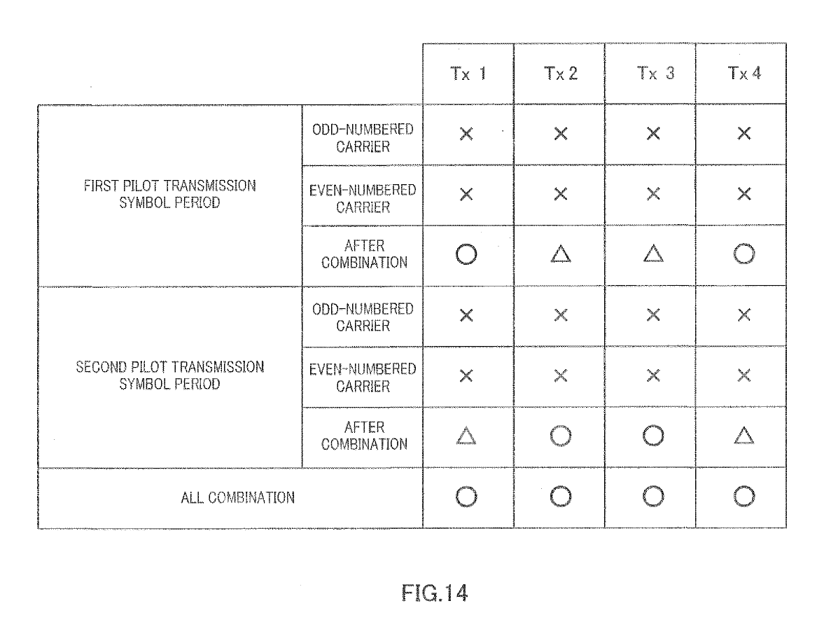

On the other hand, according to the MIMO transmission apparatus of the present embodiment, the accuracy of channel estimation improves for any Tx1, Tx2, Tx3 and Tx4. FIG. 14 is a drawing showing the trend of the quality of channel estimation values obtained on the receiving side when pilots are transmitted in the order shown in FIG. 11.

That is, Tx1 and Tx4 make a pair of the beginning transmitting antenna and the last transmitting antenna in the first pilot transmission symbol period, so that the accuracy of channel estimation values calculated based on the combined delay profile improves. Meanwhile, Tx2 and Tx3 make a pair of the beginning transmitting antenna and the last transmitting antenna in the second pilot transmission symbol period, so that the accuracy of channel estimation values calculated based on the combined delay profile improves. Therefore, the accuracy of channel estimation values improves for any transmitting antennas over the first pilot transmission symbol period and the second pilot transmission symbol period.

As described above, according to the present embodiment, the MIMO transmission apparatus transmits pilots such that the pair of the beginning transmitting antenna and the last transmitting antenna in the first pilot transmission symbol period differs from the pair of the beginning transmitting antenna and the last transmitting antenna in the second pilot transmission symbol period.

As a result of this, even if the number of transmitting antennas increases, it is possible to improve the accuracy of channel estimation.

The disclosures of Japanese Patent Application No. 2007-323463, filed on Dec. 14, 2007 and Japanese Patent Application No. 2008-216920, filed on Aug. 26, 2008, including the specifications, drawings and abstracts, are incorporated herein by reference in their entirety.

### INDUSTRIAL APPLICABILITY

The pilot transmission method, the MIMO transmission apparatus and the MIMO reception apparatus according to the present invention are useful to allow the calculation of more accurate channel estimation values.

1. A pilot signal transmission method in a multiple-input/multiple-output transmission apparatus that transmits pilot signals in the form of impulses, the pilot signal transmission method comprising the steps of:
forming parallel pilot signals;
adjusting pilot signal transmission timings by multiplying the parallel pilot signals by a set of phase adjustment coefficients; and
transmitting the pilot signals at the adjusted pilot signal transmission timings from a plurality of transmitting antennas in pilot transmission symbol periods,
wherein an order of the plurality of transmitting antennas varies, per subcarrier group, in accordance with the adjusted pilot signal transmission timings in the same pilot transmission symbol period.

2. The pilot transmission method according to claim 1, wherein an adjusted pilot signal transmission timing from a second transmitting antenna is earlier than an adjusted pilot signal transmission timing from a first transmitting antenna in a first subcarrier group, while the adjusted pilot signal transmission timing from the first transmitting antenna is earlier than the adjusted pilot signal transmission timing from the second transmitting antenna in a second subcarrier group.

3. The pilot transmission method according to claim 2, wherein the first and second subcarrier groups are an odd-numbered subcarrier group and an even-numbered subcarrier group, respectively.

4. The pilot transmission method according to claim 2, wherein, on each subcarrier group, a difference in the adjusted pilot signal transmission timings provided between pilots transmitted from the first transmitting antenna and the second transmitting antenna varies between a first frame and a second frame.

5. The pilot transmission method according to claim 2, wherein a difference in the adjusted pilot signal transmission timings provided between pilots transmitted from the first transmitting antenna and the second transmitting antenna in the same frame varies between the first and second subcarrier groups.

6. The pilot transmission method according to claim 2, wherein a pair of transmitting antennas placed first or last in order varies between a first pilot transmission symbol period and a second pilot transmission symbol period.

7. A multiple-input/multiple-output transmission apparatus that transmits pilot signals in the form of impulses, comprising:
a parallel pilot signal forming section that forms parallel pilot signals; and
a pilot transmitting section that has a phase adjusting section to adjust pilot signal transmission timings by multiplying the parallel pilot signals by a set of phase adjustment coefficients, and transmits the pilot signals from a plurality of transmitting antennas in pilot transmission symbol periods,
wherein the pilot transmitting section varies, per subcarrier group, an order of the plurality of transmitting antennas in accordance with the adjusted pilot signal transmission timings in the same pilot transmission symbol period.

8. The multiple-input/multiple-output transmission apparatus according to claim 7, wherein the pilot transmitting section transmits the pilot signals such that an adjusted pilot signal transmission timing from a second transmitting antenna is earlier than a n adjusted pilot signal transmission timing from a first transmitting antenna in a first subcarrier group, while the adjusted pilot signal transmission timing from the first transmitting antenna is earlier than the adjusted pilot signal transmission timing from the second transmitting antenna in a second subcarrier group.

9. The multiple-input/multiple-output transmission apparatus according to claim 8, wherein the first and second subcarrier groups are an odd-numbered subcarrier group and an even-numbered subcarrier group, respectively.

10. The multiple-input/multiple-output transmission apparatus according to claim 8, wherein the pilot transmitting section varies, between a first frame and a second frame, a difference in the adjusted pilot signal transmission timings provided between pilots transmitted from the first transmitting antenna and the second transmitting antenna on each subcarrier group.

11. The multiple-input/multiple-output transmission apparatus according to claim 8, wherein the pilot transmitting section varies, between the first and second subcarrier groups, a difference in the adjusted pilot signal transmission timings provided between pilots transmitted from the first transmitting antenna and the second transmitting antenna in the same frame.

12. The multiple-input/multiple-output transmission apparatus according to claim 8, wherein the pilot transmitting section varies a pair of transmitting antennas placed first or last in order between a first pilot transmission symbol period and a second pilot transmission symbol period.

13. A multiple-input/multiple-output reception apparatus that receives pilot signals transmitted such that an order of a plurality of transmitting antennas in accordance with pilot transmission timings varies per subcarrier group in the same pilot transmission symbol period, the multiple-input/multiple-output reception apparatus comprising:
a group delay profile creating section that separates the received pilot signals into components for each subcarrier group and creates a group delay profile corresponding to each sub carrier group;
a sampling section that samples first partial delay profiles of first predetermined samples and last partial delay profiles of last predetermined samples in each group delay profile;
a combining section that combines the first partial delay profile and the last partial delay profile sampled in different group delay profiles after adjusting their reference positions, to generate a combined delay profile; and
a channel estimation value calculating section that calculates channel estimation values based on the combined delay profile corresponding to each transmitting antenna obtained in the combining section.

14. The multiple-input/multiple-output reception apparatus according to claim 13, wherein the combining section combines powers of paths appearing in the same positions in both the partial delay profiles and removes paths appearing in only one of the partial delay profiles.
